(19) United States
(12) Patent Application Publication
(10) Pub. No.: US 2018/0220668 A1
(43) Pub. Date: Aug. 9, 2018

(54) FAT-FREE READY-TO-DRINK BEVERAGES WITH IMPROVED TEXTURE BY CONTROLLED PROTEIN AGGREGATION

(71) Applicant: NESTEC S.A., Vevey (CH)

(72) Inventors: Alexander A. Sher, Dublin, OH (US); Virginie Kapchie, Dublin, OH (US); Veena Prabhakar, Dublin, OH (US); Madansinh Nathusinh Vaghela, Macedonia, OH (US); Philippe Rousset, Dublin, OH (US)

(21) Appl. No.: 15/749,549

(22) PCT Filed: Aug. 3, 2016
(86) PCT No.: PCT/EP2016/068504

§ 371 Date: Feb. 1, 2018

Related U.S. Application Data
(60) Provisional application No. 62/201,959, filed on Aug. 6, 2015.

(51) Int. Cl. A23C 9/154; A23C 9/152; A23L 2/46; A23L 2/56; A23L 2/60; A23L 2/66; A23L 2/68

(52) U.S. Cl. CPC A23C 9/1542; A23V 2300/26; A23L 2/46; A23L 2/56; A23L 2/60; A23L 2/66; A23L 2/68; A23C 2210/15; A23V 2002/00; A23V 2250/042; A23V 2250/5036; A23V 2250/51082; A23V 2250/51084; A23V 2250/54252; A23V 2250/628; A23C 9/1522

(57) ABSTRACT

The present invention relates to beverage products. In particular, the invention is concerned with a protein system induced by controlled aggregation of milk proteins which imparts outstanding sensory attributes on beverage product, in particular when containing no fat and/or reduced sugar. A method of producing such beverage and the products obtainable from the method are also part of the present invention.

### FIELD OF THE INVENTION

The present disclosure generally relates to milk containing beverages with improved texture/mouthfeel by controlled protein aggregation (CPA) at ultra-high temperature (UHT) treatment conditions using all-in-one process. More specifically, the present disclosure relates to ready to drink (RTD) fat-free and reduced sugar beverages containing milk and a hydrocolloid/based stabilizing system and also relates to methods for making the same.

### BACKGROUND OF THE INVENTION

The current trend is that consumers are more health conscious and are looking for healthier beverages such as fat-free with reduced sugar and without compromising the product taste and texture. In addition, consumers demand a healthier beverage, yet they are not willing to give up the original, indulgent mouthfeel (also denoted as richness, texture or creaminess) of the beverages they grew up with and remember. Thus, many RTD beverages are transitioning from high sugar and/or fat versions to versions with less sugar and/or fat to limit the calories in the beverage. However, sugar and/or fat reduction results in a thin, less pleasing mouthfeel of the beverages. Therefore, there is a need for a solution that improves and compensates the loss of mouthfeel in reduced sugar/fat-free RTD milk beverages to maintain the consumer preference.

It is critical not only to enhance texture/mouthfeel of RTD milk beverage but also have stable liquid beverages without compromising product stability over shelf life (at least 6 months at refrigeration for extended shelf life (ESL) products; and 7 months at refrigeration, 6 months at 20° C., 4 months at 30° C. and 2 months at 38° C. for aseptic products).

The present invention relates to stabilizing systems and composition of fat-free shelf-stable aseptically packaged liquid RTD milk beverages, and to the process of making thereof.

### SUMMARY OF THE INVENTION

The present disclosure provides a ready-to-drink (RTD) fat-free milk beverage and also provides methods for making such beverages. The RTD fat-free milk beverages can be extended shelf life (ESL) or aseptic, and can have a pleasant mouthfeel. The RTD fat-free milk beverages can have an improved physico-chemical stability during storage, e.g., stable for at least 7 months at refrigeration for ESL products; and 7 months at refrigeration, 6 months at 20° C., 4 months at 30° C. and 2 months at 38° C. for aseptic products. The milk beverage eliminates gelation and overcome problems with other phase separation/instability issues during different storage conditions over the full life of the milk beverages.

The objective of the present invention relates to solving the problems of (i) lack of texture/mouthfeel in fat-free/reduced sugar RTD and (ii) physical instability issues of fat-free/reduced sugar RTD.

The benefits of the present invention includes the following:
Significantly simplified process in aseptic dairy RTD beverages;
Ability to produce low calories aseptic RTD beverages with indulgent creamy, thick product texture/mouthfeel;
Enable the product to keep the unique texture and taste during its shelf life;
Provide enhanced shelf-life physical stability without syneresis, sedimentation, creaming; and
Avoid gelation issues.

Thus, the present invention now solves the foregoing problems by providing a stable beverage composition having enhanced or improved organoleptic properties.

Provided is composition of aseptic shelf-stable liquid RTD milk beverage, formed by the interaction of milk proteins (such as casein and whey), carbohydrate(s), and stabilizers. The composition may optionally comprise sweetener(s), buffers and flavor(s).

In a first aspect, the invention relates to a ready to RTD milk beverage comprising:
Fat-free milk comprising casein and whey proteins;
Added carbohydrate less than 5 wt/wt %;
an acidifier; and
a stabilizing system comprising a co-processed microcrystalline cellulose (MCC), carboxymethyl cellulose (CMC) in the range of about 0.09-0.15 wt/wt %, and carrageenan in the range of about 0.01-0.03 wt/wt %, and high acyl gellan gum in the range of 0.01 to 0.03 wt/wt %;
wherein the beverage comprises casein-whey protein aggregates having a volume based mean diameter value D [4,3] ranges from 7 to 15 μm as measured by laser diffraction. The aseptic RTD milk beverages are shelf-stable at 4° C. for at least 7 months, at 20° C. for at least 6 months, for at least 4 months at 30° C., and for at least 2 month at 38° C. The ESL RTD milk beverages are shelf-stable at 4° C. for at least 6 months.

It is well known that fat contributes significantly to the perception of texture/creamy mouthfeel of dairy beverages, wherein higher fat content results in increased texture/mouthfeel perception. Indeed, for example, viscosity as well as texture/mouthfeel of 2% fat milk or whole milk is significantly higher as compared to that of skim milk. In the present invention it was surprisingly found that texture/mouthfeel of the skim milk based beverage produced using the new controlled protein aggregation was higher than that of 2% fat milk based beverage produced as reference.

Thus based on the above teaching, a person skilled in the art would assume that the beverage with 1% fat milk would have better texture/mouthfeel as compared to the fat free variant due to the positive effect of fat content on product texture. However on the contrary, it was unexpectedly found that the present invention with fat free composition having a controlled protein aggregation resulted in increased sensory texture attributes for the fat free beverage as compared to the 1% fat milk beverage.

Furthermore, the products of the invention present excellent organoleptic properties, in particular in terms of texture and mouthfeel even when no fat or reduced sugars are used. Besides, the products of the invention show good stability over extended product shelf-life. Another aspect of the present invention relates to a method of producing a RTD milk beverage comprising the steps of:
Mixing ingredients as defined above;
adjusting pH to 6.25 to 6.4 using the acidifier;
Homogenizing the mixture at total pressure ranging from 135-300 bars and temperature ranging from 65-80° C.;
Sterilizing at UHT conditions at 136-150° C. for 3-30 seconds
Cooling the obtained beverage base product to 25° C. or below; and
Filling aseptically UHT beverages in aseptic containers.

### BRIEF DESCRIPTION OF FIGURES

FIG. 1 represents gelation of beverages prepared with (A) and without controlled protein aggregation (B) after 7 months storage at 4° C.

FIG. 2 represents technical sensory texture evaluation of beverages prepared with and without controlled protein aggregation (CPA) as compared to the sample containing 2% milk fat (100% score).

### DETAILED DESCRIPTION OF THE INVENTION

In the following description, the % values are in wt/wt % unless otherwise specified.

The present invention pertains to protein containing beverage, more particularly to RTD beverage. The present invention addresses the following issues:
Significantly improved product texture/mouthfeel of fat-free/reduced sugar RTD milk beverages
Developed beverage with no physical instability issues of fat-free/reduced sugar RTD milk beverages
Provided stable RTD milk beverages with unique texture and taste during product shelf life

There are no current solutions using controlled protein aggregation for shelf stable RTD milk beverages with low sugar/fat content which have a mouthfeel similar to full sugar beverages and are shelf-stable during the life of the beverage.

Advantageously and unexpectedly, a unique combination of the hydrocolloid stabilizing system ingredients, specific ratio of casein to whey proteins, specific combination of pH, heat and holding time were found to improve beverage texture/mouthfeel and provide a pleasant, smooth creamy taste of RTD milk beverage. In addition, the desired texture improvement and desired product shelf life stability was found only when the homogenization was done prior to applying specific combination of pH, heat and holding time for controlled protein aggregation.

As a result, the fat-free/reduced sugar RTD milk beverage has improved texture and good physico-chemical stability during shelf life. The novel hydrocolloid texturizing/stabilizing system includes stabilizing system comprising a mixture of microcrystalline cellulose (MCC), carboxymethyl cellulose (CMC) in the range of about 0.09-0.15 wt/wt %, and carrageenan in the range of about 0.01-0.03 wt/wt %, and high acyl gellan gum in the range of 0.01 to 0.03 wt/wt %.

If we use the hydrocolloids outside the above ranges, gelation or phase separation issues (e.g. serum, sedimentation) will occur (examples within and outside of the ranges are provided below).

In a first aspect, the invention relates to a RTD milk beverage comprising:
a milk component comprising casein and whey proteins,
a flavor component selected from the group consisting of a cocoa component,
a fruit flavor component, and a combination thereof;
a sugar
an acidifier
a stabilizing system comprising a co-processed microcrystalline cellulose (MCC), carboxymethyl cellulose (CMC) in the range of about 0.09-0.15 wt/tw %, and carrageenan in the range of about 0.01-0.03 wt/wt %, and high acyl gellan gum in the range of about 0.01 to 0.03 wt/wt %.

The beverage comprises casein-whey protein aggregates having a volume based mean diameter value D[4,3] of at least 3 μm as measured by laser diffraction.

In one embodiment of the present invention, the carrageenan is present and ranges from 0.01 to about 0.03 wt/wt % of the beverage.

In one embodiment of the present invention, the MCC and CMC are present in co-processed forms and wherein the amount ranges from about 0.09 to about 0.15 wt/wt %.

In one embodiment of the present invention, the high acyl gellan gum are present in coprocessed forms and wherein the amount ranges from about 0.01 to about 0.03 wt/wt %.

In one embodiment of the present invention, the acidifier comprises but not limited to lactic acid, glucono delta-lactone, phosphoric acid, ascorbic acid, acetic acid, citric acid, malic acid, hydrochloric acid, or combination of thereof.

The term “glucono delta-lactone” is a lactone (cyclic ester) of D-gluconic acid. Upon addition to water, glucono delta-lactone is partially hydrolysed to gluconic acid, with the balance between the lactone form and the acid form established at chemical equilibrium.

In one embodiment of the present invention, the RTD milk beverage further comprises calcium salts for calcium fortification.

In one embodiment of the present invention, the calcium salt comprises but not limited to calcium carbonate, calcium phosphate, calcium lactate-citrate, calcium citrate, or combination of thereof.

In an embodiment, the product includes addition of sugar, wherein sugar is sucrose up to about 5 wt/wt %.

In an embodiment, the RTD beverage further comprises additional whey proteins to improve the CPA effect and enrichment in dairy proteins.

In an embodiment, the product includes addition of natural and/or artificial sweeteners.

In an embodiment, the product includes addition of cocoa powder, flavours such as chocolate, vanilla, banana, strawberry, raspberry, milk or combination of thereof.

### Liquid Beverage Composition and Product

A beverage composition according to the invention comprises the RTD milk beverage as described in the present invention and may be any beverage composition, meant to be consumed by a human or animal, such as e.g. a beverage, e.g. a coffee beverage, a cocoa or chocolate beverage, a malted beverage, a fruit or juice beverage, or a milk based beverage; a performance nutrition product, a medical nutrition product; a milk product, e.g. a milk drink, a product for improving mental performance or preventing mental decline, or a skin improving product.

### Beverage or Beverage Composition

A beverage according to the invention comprises the RTD milk beverage as described in the present invention and may e.g. be in the form of a ready-to-drink beverage. By a ready-to-drink beverage is meant a beverage in liquid form ready to be consumed without further addition of liquid. A beverage according to the invention may comprise any other suitable ingredients known in the art for producing a beverage, such as e.g. sweeteners, e.g. sugar, such as invert sugar, sucrose, fructose, glucose, or any mixture thereof, natural or artificial sweetener; aromas and flavors, e.g. fruit, cola, coffee, or tea aroma and/or flavor; fruit or vegetable juice or puree; milk; stabilizers; natural or artificial color; preservatives; antioxidants, or combination of thereof.

A ready-to-drink beverage may be subjected to a heat treatment to increase the shelf life or the product, UHT (Ultra High Temperature) treatment, HTST (High Temperature Short Time) pasteurization, batch pasteurization, or hot fill.

Milk protein containing liquid beverages are beverages or beverage concentrates containing milk (e.g. fluid, fat-removed, lactose-removed, powder, concentrate, fractionated) or the proteins obtained, whether native or modified, from milk, or a mixture thereof.

According to a particular embodiment, the pH of preheat treatment stage is controlled by the presence of an acidic component. The acidic component is preferably selected but not limited from the group consisting of lactic acid, glucono delta-lactone, phosphoric acid, ascorbic acid, acetic acid, citric acid, malic acid, hydrochloric acid, molasses, fruit derived acids and fermentation derived acids.

According to a particular embodiment, the product according to the invention comprises about 0 to about 2 wt/wt % fat, up to about 3.5 wt/wt % protein and sweetening agent, e.g. sugar from about 0 to 4.5 wt/wt %.

By “sweetening agent” it is to be understood an ingredient or mixture of ingredients which imparts sweetness to the final product. These include natural sugars like cane sugar, beet sugar, molasses, other plant derived nutritive and non-nutritive sweeteners, and chemically synthesized non-nutritive high intensity sweeteners.

The removal of fat in beverages without compromising the indulgent quality of the product is one of the main challenges faced by the industry. The present invention is overcoming this issue in providing fat-free products with similar texture and sensory attributes than those having higher fat contents in terms of texture/mouthfeel.

The products include a stabilizer system.

A “stabilizer system” is to be understood as an ingredient or a mixture of ingredients which contributes to the stability of the beverage product with respect to shelf life. Thus, the stabilizer system may comprise any ingredients which provide physical stability to the beverage.

The stabilizer system that may be used in the present products comprises a co-processed microcrystalline cellulose (MCC), carboxymethyl cellulose (CMC) in the range of about 0.09-0.15 wt/wt %, and carrageenan in the range of about 0.01-0.03 wt/wt % and high acyl gellan gum in the range of about 0.01-0.03 wt/wt %.

The product may additionally comprise flavors or colorants. These are used in conventional amounts which can be optimized by routine testing for any particular product formulation. It has been surprisingly found out that the presence of this controlled protein aggregation system in a beverage according to the invention improves the sensory profile of the product and in particular that it enhances considerably the smooth and creamy texture of said beverage that contains this system.

The present invention is a directed controlled protein aggregation system produced by an acidic component and specific pre-heat treatment conditions, i.e. specific combination pH, temperature and holding time in proteins such as milk proteins, which has shown to considerably improve the mouthfeel and creaminess of the beverage of the invention. Furthermore, the product of the invention has proven to be particularly stable, both when refrigerated as well as when kept at room temperature for consumption.

The invention relates in a further aspect to the use of a controlled protein aggregation system including casein and whey proteins for manufacturing a beverage with a heat treatment at pH between 6.25 and 6.4. The invention relates in a further aspect of heating to temperature ranging from 136 to 150° C. and holding for 3 seconds to 30 seconds.

Such a system offers the unexpected advantage that it can confer to the beverage product exceptional sensory attributes with good stability while removing fat and reducing sugar content.

The homogenization step of the present invention may be performed in one or two steps. The two step homogenization approach comprises the first step wherein liquid mixture is exposed to a pressure in the range of 100 to 250 bars and followed by a second step having pressure in the range of 35 to 50 bars.

The process of the invention has surprisingly proven to enhance the textural experience of beverages according to the invention even at no fat and/or reduced sugar contents. The applicant has discovered that combination of stabilizing system with the following process parameters such as the pH, specific heat treatment and holding time results in a product with smooth, creamy texture and superior shelf life stability when compared to typical beverage products. In addition, it is critical to have a homogenization step before the specific heat treatment.

According to a particular embodiment, the beverage according to the invention comprises an acidic component. The acid component is preferably selected but not limited from the group consisting of lactic acid, glucono delta-lactone (GdL), phosphoric acid, ascorbic acid, acetic acid, citric acid, malic acid, hydrochloric acid, molasses, fruit derived acids and fermentation derived acids, or combination of thereof.

The method of the invention lends itself to the manufacture of beverages according to the invention which are shelf-life stable at the necessary storage temperatures and have superior organoleptic and textural properties.

### EXAMPLES

The present invention is illustrated further herein by the following non-limiting examples. In this and in the all other examples of the invention, concentrations of ingredients are given as wt/wt % based on the whole product formulation.

Fat-free milk was used in preparation of all samples described in the examples below. Particle size distribution was determined by using a laser light scattering Mastersizer 3000 MA (Malvern Instrument) equipped with Hydro 2000G dispersion unit. The weighted volume mean D [4,3] were reported.

### Example 1

Process without Controlled Protein Aggregation (CPA)

The RTD beverages can be made by the following process:
Hydration (e.g., wetting) of cocoa powder for 45 minutes at 90° C. to form the cocoa slurry.
A co-processed microcrystalline cellulose (MCC) and carboxymethyl cellulose (CMC) were dry blended with carrageenan, high acyl gellan, and sucrose and then were added under high agitation to a separate tank containing fluid milk
Addition under agitation of the cocoa slurry to the fluid milk tank containing hydrocolloids
Addition under agitation of rest of ingredients such as sweetener, other flavors, and minerals.
Aseptic homogenization at 135/35 bars at 70° C.
Subjection of the beverage to ultra-high temperature (“UHT”) heat treatment at about 141° C. for about 3 seconds
The UHT treatment is followed by cooling below 25° C. and aseptic filling of the RTD beverage into a suitable aseptic container, e.g. PET bottles, Tetra Pak®, jars, jugs or pouches.

### Example 2

Process with CPA

The RTD beverage with controlled protein aggregation was prepared as in Example 1, but with addition of lactic acid before aseptic homogenization to adjust pH to 6.3 (measured at 4° C.).

### Example 3

Reference (Process without CPA)

The RTD beverage with controlled protein aggregation was prepared as in Example 1 process, using 90 kg of fat-free milk, 450 g of nonfat dry milk, 145 g of co-processed microcrystalline cellulose (MCC) and carboxymethyl cellulose (CMC), 20 g of high acyl gellan, 10 g of carrageenan, 4.2 kg sugar, 500 g of cocoa, 150 g of calcium carbonate and water necessary to reach 100 kg of the final beverage.

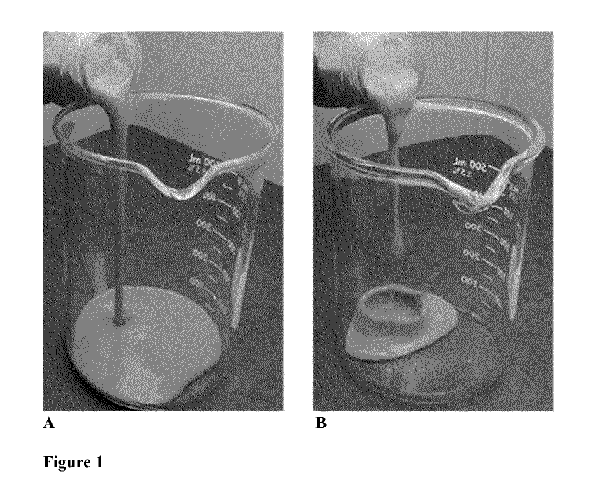

Beverage physico-chemical properties were evaluated and sensory characteristics were judged by trained sensory panelists. Gelation issues were found during shelf life (FIG. 1B).

### Example 4

Sample (Process with CPA)

The RTD beverage was prepared as in Example 3 but with addition of 20 g high acyl gellan gum, and 65 g of lactic acid before aseptic homogenization.

Beverage physico-chemical properties were evaluated and sensory characteristics were judged by trained sensory panelists.

No phase separation including syneresis, gelation (FIG. 1A), marbling and no sedimentation were found in sample during shelf-life.

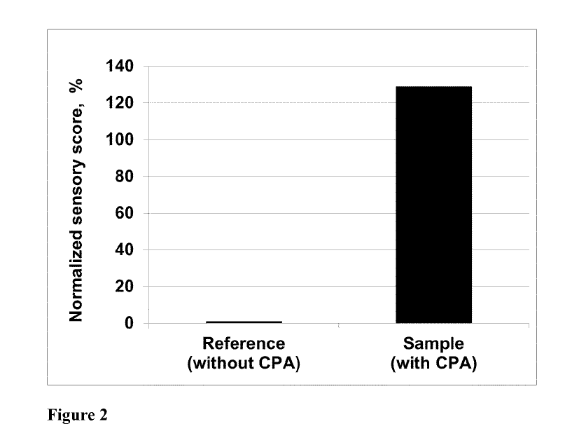

The beverage had a significantly increased viscosity and significantly improved texture/mouthfeel. Results of sensory texture evaluation as compared to the sample containing 2% milk fat (100% score) are shown in FIG. 2.

A volume based mean diameter value D [4,3] determined by laser diffraction was about 10 μm.

### Example 5

The RTD beverage was prepared as in Example 4, but without the addition of cocoa to eliminate fat contribution from the cocoa powder.

The beverage without the cocoa had similar texture/mouthfeel and physical stability compared to the beverage with the cocoa.

### Example 6

The fat-free RTD beverage was prepared as in Example 4.

The 1% milk fat RTD beverage was prepared as in Example 4, but using 1% fat milk.

The 2% milk fat RTD beverage was prepared as in Example 3, but using 2% fat milk.

The improvement in sensory texture score of the fat-free RTD beverage with CPA was significantly higher as compared to that of 1% milk fat RTD beverage with CPA as well as the 2% milk fat beverage (sample without CPA, 100% score). Results of fat-free RTD beverage with and without CPA showed significant improvement in sensory texture attribute as presented in FIG. 2.

### Example 7

The RTD beverage was prepared as in Example 4, but with aseptic homogenization step performed after the UHT process.

The beverage had a significantly reduced mouthfeel/texture as well as stability when compared to the beverage with aseptic homogenization step performed prior to the UHT process as described in Example 4.

1. A ready to drink (RTD) beverage product comprising:
fat-free milk;
added carbohydrate less than 5 wt/wt %;
an acidifier;
a stabilizing system comprising a co-processed microcrystalline cellulose, carboxymethyl cellulose in the range of about 0.09-0.15 wt/wt %, and carrageenan in the range of about 0.01-0.03 wt/wt % and high acyl gellan gum in the range of 0.01 to 0.03 wt/wt %; and
the beverage comprises casein-whey protein aggregates having a volume based mean diameter value D [4,3] is from 7 to 15 μm as measured by laser diffraction.

2. The RTD beverage of claim 1 wherein the acidifier is selected from the group consisting of lactic acid, glucono delta-lactone, phosphoric acid, ascorbic acid, citric acid, malic acid and combinations thereof.

3. The RTD beverage of claim 1 wherein the acidifier is lactic acid.

4. The RTD beverage of claim 1 comprising a component selected from the group consisting of calcium carbonate, calcium phosphate, calcium lactate-citrate, calcium citrate, and combinations thereof.

5. The RTD beverage of claim 1, wherein sugar is sucrose up to about 5 wt/wt %.

6. The RTD beverage of claim 1 comprising a flavor comprising fruit flavor or cocoa.

7. The RTD beverage of claim 1 comprising cocoa.

8. The RTD beverage of claim 1 further comprises additional whey proteins.

9. A method of producing a RTD beverage comprising the steps of:
mixing fat-free milk; added carbohydrate less than 5 wt/wt %; an acidifier; a stabilizing system comprising a co-processed microcrystalline cellulose, carboxymethyl cellulose in the range of about 0.09-0.15 wt/wt %, and carrageenan in the range of about 0.01-0.03 wt/wt % and high acyl gellan gum in the range of 0.01 to 0.03 wt/wt %; and the beverage comprises casein-whey protein aggregates having a volume based mean diameter value D [4,3] is from 7 to 15 μm as measured by laser diffraction;
adjusting pH to 6.25 to 6.4 using the acidifier;
homogenizing the mixture at total pressure ranging from 135-300 bars and temperature ranging from 65-80° C.;
sterilizing at UHT conditions at 136-150° C. for 3-30 seconds;
cooling the obtained beverage base product to 25° C. or below; and
filling aseptically UHT beverages in aseptic containers.

10. The process of claim 9, wherein the homogenization is in two steps comprising the first step wherein liquid mixture is exposed to a pressure in the range of 100 to 250 bars and followed by a second step having pressure in the range of 35 to 50 bars.
